(19) United States
(12) Patent Application Publication
(10) Pub. No.: US 2022/0044689 A1
(43) Pub. Date: Feb. 10, 2022

(54) AUTHENTICATION METHOD, AUTHENTICATION SYSTEM, SMART SPEAKER AND PROGRAM

(71) Applicant: Hakushitorock Co., Ltd., Osaka (JP)

(72) Inventor: Issei WATANABE, Osaka-shi (JP)

(73) Assignee: Hakushitorock Co., Ltd., Osaka (JP)

(21) Appl. No.: 17/425,275

(22) PCT Filed: Jun. 16, 2020
(86) PCT No.: PCT/JP2020/023575

§ 371 Date: Jul. 22, 2021

(30) Foreign Application Priority Data
Jan. 20, 2020 (JP) 2020-006570

(51) Int. Cl. G10L 17/24; G10L 17/06; G06F 21/32

(52) U.S. Cl. CPC G10L 17/24; G06F 21/32; G10L 17/06

(57) ABSTRACT

An authentication method includes a first step and a second step. The first step causes a voice including a predetermined character string to be output from a speaker 23. The second step acquires voice information by receiving an utterance voice of the target user via a microphone 21 after the first step, and determines from the voice information whether the target user is the specific user or not. In the second step, it is determined whether a character string recognized from the voice information is matched to the predetermined character string. In the second step, it is determined whether characteristics of the utterance voice of the target user is matched to characteristics of the voice of the target user based on a characteristics amount recognized from the voice information and a characteristics amount of voice information registered in advance as the voice of the specific user.

### TECHNICAL FIELD

The present invention relates to an authentication method, an authentication system, a device and a program.

### BACKGROUND ART

Patent Literature 1 discloses a conventional authentication method. The conventional authentication method disclosed in the Patent Literature 1 is a login method in which a voiceprint is utilized. The login method disclosed in the Patent Literature 1 generates a login character string when a login request is performed by a user, replaces at least one character of the login character string, and displays a replaced character string.

After confirming the displayed character string, the user reads aloud the login character string that is before replacement. According to the login method disclosed in the Patent Literature 1, the voiceprint of the user who reads aloud the character string is acquired to determine whether the login character string is correct or not, and in addition to this, a voiceprint authentication based on the voice is also executed.

### CITATION LIST

### Patent Literature

Patent Literature 1: Japanese Patent Application Publication No. 2017-530387

### SUMMARY OF INVENTION

### Technical Problem

However, with the login method disclosed in the Patent Literature 1, since the login character string is to be displayed, a person with visual impairment such as an elderly person with weak eyesight or a blind person cannot login. Furthermore, when the user's hands are occupied due to driving, cooking, parenting, delivering and so on, it is difficult to visually recognize the character string, and therefore there is a problem that the user cannot login. Accordingly, a more user-friendly method is required.

The present invention has been made in view of the above circumstances, and an object of the present invention is to provide an authentication method, an authentication system, a device and a program which are more convenient to use and can authenticate the person with visual impairment and the user whose hands are occupied due to driving, cooking, parenting, delivering and so on.

### Solution to Problem

An authentication method according to one aspect of the present invention is an authentication method for authenticating whether a target user is a specific user registered in advance or not. The authentication method includes a first step and a second step. The first step causes a voice including a predetermined character string to be output from a speaker. The second step acquires voice information by receiving an utterance voice of the target user via a microphone after the first step, and determines from the voice information whether the target user is the specific user or not. In the second step, at least two determinations are to be executed. In one determination, it is determined whether a character string recognized from the voice information is matched to the predetermined character string. In the other determination, it is determined whether characteristics of the utterance voice of the target user is matched to characteristics of the voice of the target user based on a characteristics amount recognized from the voice information and a characteristics amount of voice information registered in advance as the voice of the specific user.

An authentication system according to one aspect of the present invention has a speaker, a microphone and a control unit. The control unit causes a voice including a predetermined character string to be output from the speaker. The control unit acquires voice information by receiving an utterance voice of a target user via the microphone thereafter, and determines from the voice information whether the target user is a specific user or not. In the determination, a determination whether a character string recognized from the voice information is matched to the predetermined character string, and a determination whether characteristics of the utterance voice of the target user is matched to characteristics of the voice of the target user based on a characteristics amount recognized from the voice information and a characteristics amount of voice information registered in advance as the voice of the specific user are executed.

A device according to one aspect of the present invention has a speaker, a microphone and a control unit. The control unit causes a voice including a predetermined character string to be output from the speaker. The control unit acquires voice information by receiving an utterance voice of a target user via the microphone thereafter, and determines from the voice information whether the target user is a specific user or not. In the determination, a determination whether a character string recognized from the voice information is matched to the predetermined character string, and a determination whether characteristics of the utterance voice of the target user is matched to characteristics of the voice of the target user based on a characteristics amount recognized from the voice information and a characteristics amount of voice information registered in advance as the voice of the specific user are executed.

A program according to one aspect of the present invention is a program causing a computer to execute the aforementioned authentication method.

### Effect of the Invention

The authentication method, the authentication system, the device and the program according to the above aspects of the present invention each has an advantage that even the person with visual impairment can be authenticated. Also, with the authentication method, the authentication system, the device and the program according to the above aspects of the present invention, even if the user's hands are occupied due to driving, cooking, parenting, or delivering luggage, the user can be authenticated in a natural conversation without manually inputting something or displaying something on the screen. Also, with the authentication method, the authentication system, the device and the program according to the above aspects of the present invention, in the second step, the two types of determinations are executed with the once utterance of the user, and therefore the user does not feel of troubling at the time of the authentication.

### BRIEF DESCRIPTION OF DRAWINGS

FIG. 1 is a schematic diagram of an authentication system according to one embodiment of the present invention.

FIG. 2 is a block diagram showing a hardware configuration of a device of the authentication system.

FIG. 3 is a block diagram showing a hardware configuration of a server of the authentication system.

FIG. 4 is a block diagram showing a functional configuration of the authentication system.

FIG. 5 is a sequence diagram of the authentication system.

FIG. 6 is a flowchart of the authentication system.

FIG. 7 is a block diagram showing a device according to a modification example.

### DESCRIPTION OF EMBODIMENTS

### (1) Embodiment 1

(1.1) Outline

An authentication method according to the present embodiment is, for example, in a device 2 such as a smart speaker, a method of an authentication with a voice whether a person who intends to use the device 2 (hereinafter, referred to as “target user” or simply “user”) is a previously registered person (hereinafter, referred to as “specific user”) or not.

The device 2 is not limited to the smart speaker, and may be an information terminal such as a personal computer, a smartphone, a tablet terminal, or a wearable terminal (a clock type, a glasses type, a contact lens type, a clothing type, a shoe type, a ring type, a bracelet type, a necklace type, an earring type and so on). Furthermore, the device 2 may be a home appliance (e.g. a refrigerator, a washing machine, a gas stove, an air conditioner, a TV, a rice cooker, a microwave oven and so on), a locking device such as a front door (e.g. a smart lock system allowed to be operated by a smartphone, a card key and so on), an authentication device (e.g. an authentication of a car navigation, an authentication when performing a voice operation, an authentication for a locking or a starting, and so on) for a vehicle such as an automobile (a car and so on), a robot, an electrical equipment, and so on. Those devices are also the ones that can perform device operations (including that one device operates another device) with a voice, in a natural conversation between the user and the smart speaker. For example, when a use of the device 2 is to be started, the authentication system 1 capable of executing the authentication method according to the present embodiment permits the use of the device 2 when the target user is authenticated as the specific user.

The device 2 can also be installed indoors or outdoors. For example, the device 2 can be installed in an arbitrary place such as inside a home (e.g. a living room, a kitchen, a bathroom, a toilet, a washbasin, a tabletop, an entrance, and so on), inside an office (e.g. a tabletop, an in-trans, and so on), or inside a vehicle (e.g. a dashboard, a center console, a seat, a back seat, a backrest, a luggage compartment, and so on). Also, the device 2 may be permanently installed such as not to be portable, or may be installed such as to be portable. For example, the information terminal such as the smart speaker, the personal computer, the smartphone, the tablet terminal and the wearable terminal is portably installed. According to the device 2 portably installed, the user can set the device anywhere indoors or outdoors, and can listen to a music, an internet radio and so on. Even if the user's hand is occupied at this time, it is possible to authenticate the user in a natural conversation without manually inputting anything or displaying anything on a screen.

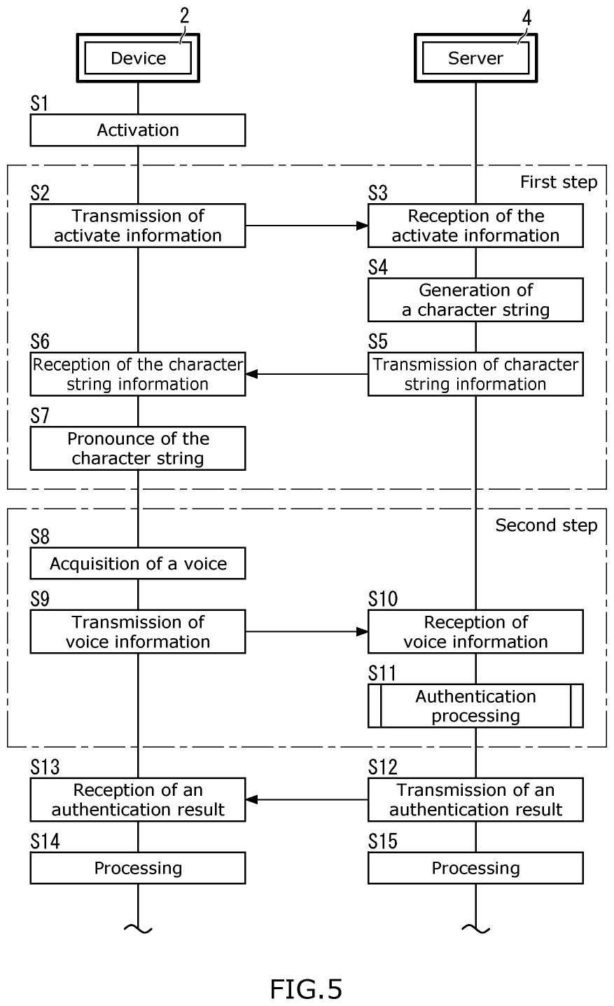

As shown in FIG. 5, the authentication method according to the present embodiment includes a first step and a second step executed after the first step. The first step causes a voice including a predetermined character string to be output from a speaker 23. The second step acquires voice information by receiving an utterance voice of the target user via a microphone 21 and determines from the voice information whether the target user is the specific user or not.

In the second step according to the present embodiment, at least two determinations are executed. One of the two determinations determines whether the character string recognized from the received voice information is matched to the predetermined character string. The another one determines whether characteristics of the voice of the target user is matched to characteristics of the voice of the specific user based on a characteristics amount recognized from the voice information and a characteristics amount of voice information registered in advance as the voice of the specific user. As a matter of course, the order in which those determinations are executed is not particularly limited.

When those determinations are executed and all are determined to be matched, the target user is considered to be the specific user. Therefore, according to the authentication method according to the present embodiment, it is possible to perform the authentication of being the registered user with only the voice.

Specific aspects thereof may be realized with a system, a device, an integrated circuit, a computer program, a recording medium such as a CD-ROM readable with a computer, etc. The specific aspects thereof may also be realized with combinations any of the system, the device, the integrated circuit, the computer program, the recording medium, etc.

(1.2) Details

Hereinafter, details shall be described based on the authentication system 1 that executes the authentication method according to the present embodiment.

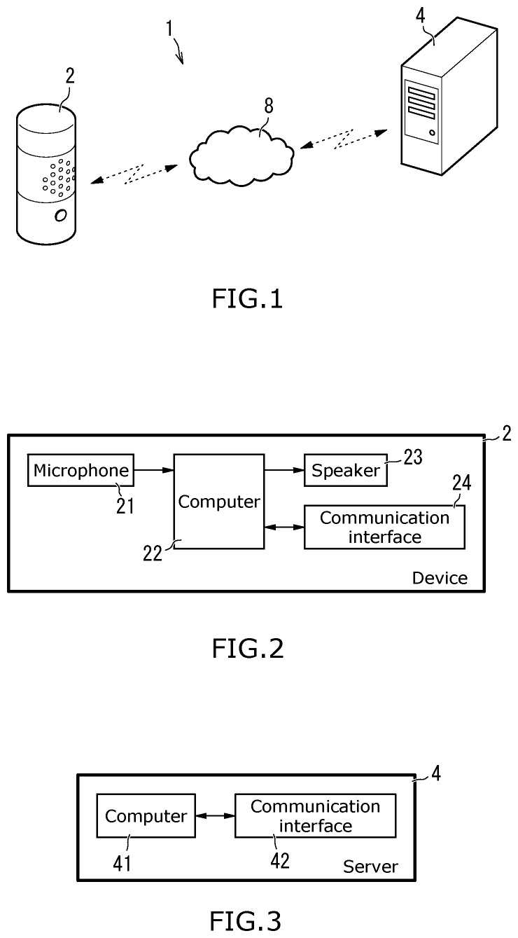

The authentication system 1 according to the present embodiment is, for example, a system configured such as to authenticate whether the target user is the specific user or not when the target user intends to use the device 2 or when the target user is using the device 2. As shown in FIG. 1, the authentication system 1 is realized by the device 2 and a server 4 in the present embodiment. The device 2 and the server 4 are bidirectionally and communicatively connected via a communication network 8.

(1.2.1) Communication Network

The communication network 8 is a bidirectional network for the device 2 and the server 4 to communicate with each other. The communication network 8 is an internet in the present embodiment, but may be, for example, a network with a limited communication range such as a corporate network.

As the communication network 8, for example, a transmission control protocol/internet protocol (TCP/IP), a mobile data communication network such as GSM (registered trademark), CDMA and LTE, Bluetooth (registered trademark), Wi-Fi (registered trademark), Z-WAVE, Insteon, EnOcean, ZigBee, HomePlug (registered trademark), MQTT (Message Queueing Telemetry Transport), XMPP (extensible messaging and presence protocol), or CoAP (constrained application protocol), or a combination thereof is exemplified.

(1.2.2) Hardware Configuration

The device 2 is a smart speaker in the present embodiment. However, the device 2 according to the present disclosure is not limited to the smart speaker, and may be an information terminal such as a personal computer, a smartphone or a tablet terminal, a home appliance, a locking device such as a front door, an authentication device of a vehicle such as an automobile, a robot, an electric device, etc. Here, a hardware configuration of the device 2 is shown in FIG. 2. As shown in FIG. 2, the device 2 according to the present embodiment has the microphone 21, a computer 22, the speaker 23 and a communication interface 24.

The microphone 21 is a microphone that collects an ambient sound. The microphone 21 digitizes an input sound and converts it into voice information. The microphone 21 is connected to the computer 22 and outputs the voice information to the computer 22.

The computer 22 has a main storage device, an auxiliary storage device, and a processor that is allowed to execute a control program for operating the device 2. The main storage device is a so-called main memory and is a volatile storage area (e.g. RAM). The auxiliary storage device is a device that stores the control program and so on, and is a non-volatile storage area (e.g. ROM). The non-volatile storage area is not limited to the ROM, and may be a hard disk, a flash memory or the like.

When the voice information is input, the speaker 23 converts it into an analog signal and output a sound. The speaker 23 is connected to the computer 22, and is configured such that the voice information output from the computer 22 is input.

The communication interface 24 is an interface that communicates with the server 4 via the communication network 8. The communication interface 24 is a wireless LAN interface in the present embodiment, but may be a wired LAN interface, a wireless WAN, a wired WAN or the like in the present disclosure.

A hardware configuration of the server 4 is shown in FIG. 3. As shown in FIG. 3, the server 4 according to the present embodiment has a computer 41 and a communication interface 42.

The computer 41 has a main storage device, an auxiliary storage device, and a processor that is allowed to execute a control program for operating the device 2. The main storage device is a so-called main memory and is a volatile storage area (e.g. RAM). The auxiliary storage device is a device that stores the control program and so on, and is a non-volatile storage area (e.g. ROM). The non-volatile storage area is not limited to the ROM, and may be a hard disk, a flash memory or the like.

The communication interface 42 is an interface that communicates with the device 2 via the communication network 8. The communication interface 42 is a wireless LAN interface in the present embodiment, but may be a wired LAN interface, a wireless WAN, a wired WAN or the like in the present disclosure.

(1.2.3) Functional Configuration

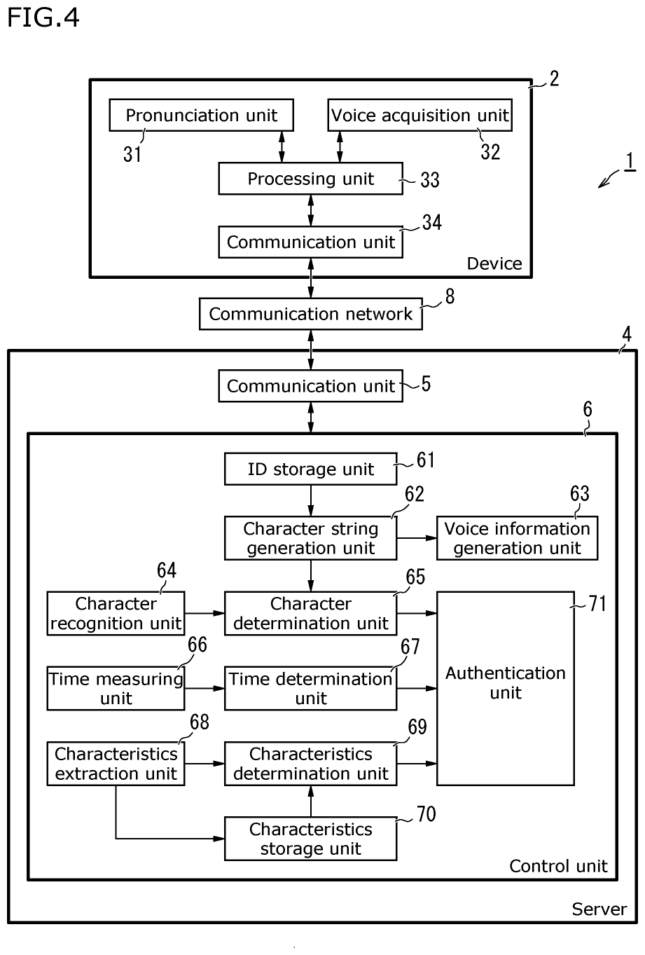

Next, a functional configuration of the authentication system 1 shall be described. As shown in FIG. 4, the device 2 includes a communication unit 34, a processing unit 33, a pronunciation unit 31, and a voice acquisition unit 32.

The communication unit 34 establishes a communication connection with the server 4 via the communication network 8 and communicates with the server 4. The communication unit 34 receives the voice information transmitted from the server 4, and outputs the received voice information to the processing unit 33. The communication unit 34 also transmits the voice information output from the processing unit 33 to the server 4. The communication unit 34 can be realized by the communication interface 24, the computer 22, or the like in the present embodiment.

The processing unit 33 executes various processes including a process that output the received voice information to the server 4 via the voice acquisition unit 32 (the microphone 21), a process that causes the voice to be output from the speaker 23 based on the received information (including the voice information) via the communication unit 34, and so on. The processing unit 33 can be realized by the computer 22 in the present embodiment.

The pronunciation unit 31 outputs the voice information, which is output from the processing unit 33, to the outside as a sound. The pronunciation unit 31 can be realized by the speaker 23 and the computer 22 in the present embodiment.

The voice acquisition unit 32 acquires the voice information by receiving the utterance voice of the user. The voice information acquired by the voice acquisition unit 32 is output to the processing unit 33. The voice acquisition unit 32 can be realized by the microphone 21 and the computer 22 in the present embodiment.

Next, a functional configuration of the server 4 shall be described. The server 4 has a communication unit 5 and a control unit 6 in the present embodiment.

The communication unit 5 establishes a communication connection with the device 2 via the communication network 8 and communicates with the device 2. The communication unit 5 receives the voice information transmitted from the device 2, and outputs the received voice information to the control unit 6. The communication unit 5 also transmits the information, which is output from the control unit 6, to the device 2. The communication unit 5 can be realized by the communication interface 42, the computer 41 and so on in the present embodiment.

The control unit 6 executes various processes based on the information input from the communication unit 5. The control unit 6 has a character string generation unit 62, an ID storage unit 61, a character recognition unit 64, a character determination unit 65, a time measuring unit 66, a time determination unit 67, a characteristics extraction unit 68, a characteristics determination unit 69, and a characteristics storage unit 70 in the present embodiment.

The character string generation unit 62 generates a character string that causes the target user to recite at a time of the authentication. The character string consists of a plurality of characters that can be pronounced. The character string is composed of, for example, a plurality of hiragana characters (here, two-letter hiragana characters including “i” and “nu” are served). However, the character string may be an arbitrary combination of characters that can be pronounced, and may be a character string consists of alphabets. The character string according to the present disclosure includes numbers as well. The character string generation unit 62 may also generate a character string composed of a random combination of hiragana characters.

The character string generation unit 62, for example, may generate the character string based on information registered in advance. As the information registered in advance, an arbitrary password, an address, a name, a birth date, a favorite food, a favorite movie, a school name, a club name, a favorite sports, etc. are exemplified.

The character string generation unit 62, for example, may generate a character string from ID information of the user stored in the ID storage unit 61. The ID information is stored in the ID storage unit 61. The ID information is, for example, registered to the ID storage unit 61 via the voice acquisition unit 32 of the device 2. “The ID information” in the present disclosure is a user name of the specific user. The user name may be a real name or a handle name.

Character string information, which is generated by the character string generation unit 62, is output to a voice information generation unit 63 and the character determination unit 65.

The voice information generation unit 63 generates the voice information from the character string information that is input from the character string generation unit 62. When the character string composed of “i” and “nu” is input from the character string generation unit 62, the voice information generation unit 63 generates the voice information of “INU” that corresponds to said character string, in the present embodiment. For example, when the character string composed of numbers of “1”, “2” and “3” is input, the voice information composed of “one two three” is generated. As the other example, when the character string composed of the alphabets of “D”, “O” and “G” is input from the character string generation unit 62, the voice information generation unit 63 may generate the voice information composed of “dog”. The voice information generated by the voice information generation unit 63 is output to the communication unit 5 and transmitted to the device 2.

As described in a flowchart below, the voice including the predetermined character string is output from the pronunciation unit 31 of the device 2. “The predetermined character string” in the present disclosure means a character string for executing the authentication. The voice is output based on the voice information generated by the voice information generation unit 63 in the present embodiment. For example, according to the present embodiment, the device 2 outputs “Please pronounce ‘inu’”, or, “Please pronounce a word ‘inu’ repeatedly” with the pronunciation unit 31. The target user who heard this can recite the word “inu”. That is, “inu” here is corresponding to the predetermined character string. As a matter of course, the device 2 may output a voice for prompting a pronunciation of the predetermined character string before and after outputting the predetermined character string. For example, the device 2 may output “Authentication shall be started from now on”, “The voice could not be heard well, please repeat the word ‘inu’ again” and so on from the pronunciation unit 31. The predetermined character string may also be an answer to a question. For example, when a question “Please tell me your name” is pronounced from the device 2, the predetermined character string to execute the authentication becomes a name such as “Taro Yamada”. The target user who heard this can recite “Taro Yamada”. As another example, when a question “Please tell me your birthday” is pronounced from the device 2, the predetermined character string to execute authentication may become “Jun. 9, 1989” and so on.

The character recognition unit 64 recognizes the character string based on the voice information from the device 2 which received the voice information via the communication unit 5. When the character recognition unit 64 receives “INU” which is the voice information from the device 2, the character recognition unit 64 recognizes “i” and “nu” each of which is one of characters of the character string. The recognition of the respective characters can be realized, for example, by a voice pattern matching technology. Character string information recognized by the character recognition unit 64 is output to the character determination unit 65.

The character determination unit 65 determines whether or not the character string generated by the character string generation unit 62 is coincided (matched) to the input character string information. For example, various methods utilizing a factor such as whether or not a correspondence is registered in a predetermined table or the like, an antonym, a synonym, a homonym, an identical character string, or a substantially identical character string can also be applied to determine whether or not the character string generated by the character string generation unit 62 is coincided (matched) to the input character string information. A result determined by the character determination unit 65 is output from the character determination unit 65, and input to an authentication unit 71.

The time measuring unit 66 measures a time until the voice information is acquired from a time when the device 2 pronounces the voice corresponding to the predetermined character string, and generates time information. That is, the time measuring unit 66 measures a time until the voice information corresponding to the utterance voice pronounced by the target user is to be acquired from a time when the first step is executed. The time measuring unit 66 is, for example, realized by a timer included in the computer 41. In the present embodiment, a time point when the device 2 is started (an authentication starting point) is recorded as a time stamp in the main memory of the server, and a time until the voice information transmitted from the device 2 is received by the communication unit 5 from the authentication starting point is defined as “the time until the voice information corresponding to the utterance voice pronounced by the target user is to be acquired from the time when the first step is executed”. However, in the present disclosure, a time until a time point when the voice is input to the voice acquisition unit 32 from a time point when the voice is output from the pronunciation unit 31 may be defined as “the time until the voice information corresponding to the utterance voice pronounced by the target user is to be acquired from the time when the first step is executed”. That is, “when the first step is executed” does not mean a time when the first step is started in the strict meaning, and it may be started from any timing during the execution of the first step.

The time information generated by the time measuring unit 66 is output to the time determination unit 67.

The time determination unit 67 determines whether or not the time information is within a threshold value when the time information output from the time measuring unit 66 is input. That is, the time determination unit 67 determines whether the time until the voice information is to be acquired from the time when the first step is executed is within a predetermined time. In the present embodiment, the threshold value is preferably an arbitrary value any of not less than 5 [s] and not more than 60 [s]. More preferably, the threshold value is an arbitrary value any of not less than 5 [s] and not more than 60 [s].

A result determined by the time determination unit 67 is output from the time determination unit 67, and output to the authentication unit 71.

The characteristics extraction unit 68 extracts characteristics amount of the voice based on the voice information from the device 2 which receives the voice information via the communication unit 5. In the present embodiment, the characteristics extraction unit 68 extracts a characteristics vector from the voice information of the utterance voice of the target user. As the extraction of the characteristics amount of the voice, methods such as an MFCC (Mel-Frequency Cepstrum Coefficients), a linear prediction (Linear Predictive Coding; LPC), a PLP (Perceptual Linier Prediction), and an LSP (Line Spectrum Pair) are exemplified. In the extraction of the characteristics amount of the voice, those methods may be combined.

Information of the characteristics amount (the characteristics vector) extracted by the characteristics extraction unit 68 is output to the characteristics determination unit 69.

The characteristics determination unit 69 determines whether the characteristics of the utterance voice of the target user is matched to the characteristics of the voice of the target user based on the characteristics amount information input from the characteristics extraction unit 68 and the characteristics amount of the voice information registered in advance in the characteristics storage unit 70 as the voice of the specific user. Determination by the characteristics determination unit 69 determines “matched”, for example, in a case in which a difference between the characteristics amount input from the characteristics extraction unit 68 and the characteristics amount of the voice information input from the characteristics storage unit 70 is not more than a threshold value. That is, the term “matched” herein does not mean an exactly the same, but it is considered to be belonged to the category of “matched” if those characteristics amounts have a same tendency.

The voice information is registered in advance in the characteristics storage unit 70 as the voice of the specific user. The registration of the characteristics amount of the voice information to the characteristics storage unit 70 is performed after the voice information input via the voice acquisition unit 32 of the device 2 is extracted by the characteristics extraction unit 68. The characteristics storage unit 70 may be realized by the non-volatile storage area in the present embodiment.

A result determined by the characteristics determination unit 69 is output from the characteristics determination unit 69 and input to the authentication unit 71.

The authentication unit 71 determines that the authentication is successful when pieces of the determination information of being all matched are input from the character determination unit 65, the time determination unit 67 and the characteristics determination unit 69. In the present embodiment, the authentication unit 71 transmits information that the authentication is successful (hereinafter referred to as success information) to the device 2 via the communication unit 5 when the authentication is successful.

On the other hand, the authentication unit 71 determines that the authentication is failure when a piece of the determination information of being mismatched is input from at least one of the character determination unit 65, the time determination unit 67, and the characteristics determination unit 69. When the authentication is determined as failure, information that the authentication is failure (hereinafter referred to as failure information) is transmitted to the device 2 via the communication unit 5.

In a case in which the success information is input to the processing unit 33 of the device 2, the processing unit 33, for example, causes the pronunciation unit 31 to output “Authentication success”, and permits a subsequent use of the device 2. On the other hand, in a case in which the failure information is input to the processing unit 33, the processing unit 33, for example, causes the pronunciation unit 31 to output “Please repeat again”, and executes the authentication again. A detailed description of an operation shall be described with reference to a flowchart.

(1.2.4) Operation

Next, the operation of the authentication system 1 is shall be described with reference to FIG. 5. FIG. 5 is a sequence diagram showing an example of the authentication method of the authentication system 1 according to the present embodiment.

The user performs some operation (e.g. power ON) to the device 2. The device 2 is accordingly activated (S1). In the device 2, after activated, when an operation that the authentication is required (e.g. when the user performs an operation such as purchasing a merchandise and so on that the authentication is required) is executed, the first step of the authentication is executed. Specifically, the device 2 transmits activate information to the server 4 via the communication network 8 (S2).

When the server 4 receives the activate information (S3), the server 4 generates the character string at the control unit 6 (S4), and transmits the generated character string information to the device 2 via the communication network 8 (S5).

The device 2 receives the character string information (S6), and causes the voice of the character string to be output from the speaker 23 (S7). Here, the device 2 outputs, for example, “Please repeat ‘INU’” and so on. The user follows the voice output from the device 2 and recites a character string corresponding thereof. Here, the user pronounces “INU”.

Next, the authentication system 1 executes the second step. The device 2 acquires the voice pronounced by the user from the microphone 21 (S8), and converts the voice into the voice information. Then, the device 2 transmits the voice information acquired here to the server 4 via the communication network 8 (S9).

When the server 4 receives the voice information (S10), the server 4 starts an authentication processing (S11). Then, the server 4 transmits a result that the authentication processing are executed to the device 2 (S12), and simultaneously stores the result in the main memory of the server 4 (S15).

The device 2 receives the authentication result (S13) and executes subsequent processes (S14).

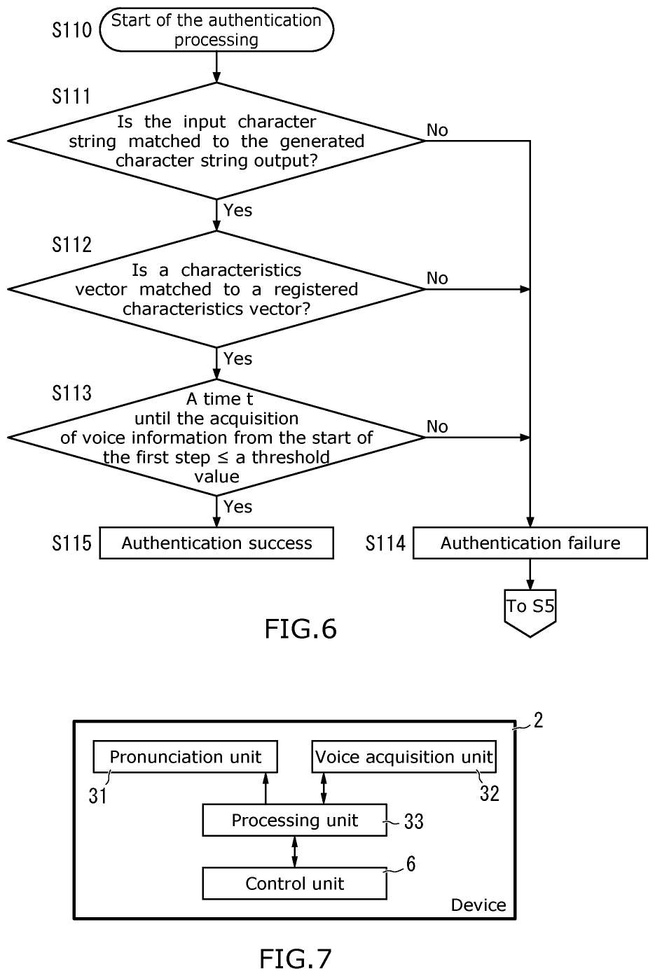

Details of the authentication processing are shown in FIG. 6. FIG. 6 is a flowchart of the authentication processing.

When the authentication processing are started (S110), the server 4 determines whether or not the character string recognized from the received voice information is matched to the character string output from the speaker 23 (the character string transmitted to the device 2) (S111).

When the character string recognized from the received voice information is determined to be matched to the character string output from the speaker 23, the determination in step 112 is proceeded, whereas when they are mismatched, a determination that the authentication is failure is made (S114).

In the step 112, a determination whether or not the characteristics vector extracted from the received voice information is matched to the characteristics vector of the voice information registered in advance is made (S112). The term “matched” herein does not only mean exactly coincide, but also includes that the characteristics vectors have a common tendency.

The determination whether or not the characteristics vector extracted by the received voice information is matched to the characteristics vector of the voice information registered in advance is made, and when a determination of being matched is made, the determination in step 113 is proceeded, whereas when a determination of being mismatched is made, a determination that the authentication is failure is made (S114).

In the step 113, a determination whether or not a time t until the voice is acquired by the microphone 21 from a time point when being output from the speaker 23 of the device 2 is not more than the threshold value is made.

When a determination that the time t until the voice is acquired by the microphone 21 from the time point when being output from the speaker 23 of the device 2 is not more than the threshold value is made, a determination that the authentication is successful is made, whereas in a chase in which the time t is more than the threshold value, a determination that the authentication is failure is made.

When the determination that the authentication is failure is made, the server 4 returns to the step 5, transmits the character string to the device 2 again, and performs authentication again. The authentication is repeatedly executed until the authentication is to be successful in the present embodiment, but times of the authentications may be restricted (e.g. 3 times), and the device 2 may be turned off when the times of the authentications exceeds that.

### (2) Modification Example

The authentication system 1 and the authentication method according to the embodiment 1 described above are merely examples of the present disclosure. Hereinafter, modification examples of the authentication system 1 and the authentication method according to the present disclosure will be enumerated. The following several modification examples and the present embodiment aforementioned can be appropriately combined and used.

In the present embodiment aforementioned, the control unit 6 has the server 4, but, as shown in FIG. 7, the control unit 6 may be realized by the computer 22 of the device 2 (see FIG. 2). In this case, it is not necessary to transmit and receive the voice information via the communication network 8. The control unit 6 has a same functional configuration as that described in the embodiment 1, and therefore the description thereof shall be omitted.

In the present embodiment aforementioned, the speaker 23 and the microphone 21 are provided in one housing, and the control unit 6 is arranged in another housing, but both of them may be housed in one housing, or each of them may be housed in a separate housing.

In the present embodiment aforementioned, “inu” is exemplified as the character string, but the character string is not limited to this, and may be a sentence (e.g. “inu is cute”) or the like, and a number of characters is not restricted. In a case in which a sentence including a subject and a predicate is selected as the character string, it is considered to be preferable because the user can easily recite even the long character string. As the matter of course, before and after outputting the predetermined character string, the voice information that allows the user to talk with the device regardless of the authentication may be output from the pronunciation unit 31 of the device.

In the present embodiment aforementioned, although the specific user to be the target of the authentication has been described as one person, but, in the present disclosure, that may be a plurality of specific users.

In the present embodiment aforementioned, the start-up of the authentication method is executed by the activation of the device 2, but, for example, the start-up of the authentication method may be instructed to the device 2 from the user terminal (e.g. the smartphone) connected such that data can be bidirectionally transmitted and received. In this case, transmission and reception of the voice may be performed via the speaker 23 and the microphone 21 of the device 2 as described above, or transmission and reception of the voice may be performed via a speaker and a microphone of the user terminal. In this case, for example, the device 2 may transmit an authentication start signal to the server 4 by triggering that the device 2 receives a signal that a specific operation (e.g. payment on the Internet) of the user terminal is executed. Then, the result of the authentication may be transmitted to the user terminal via the device 2, and the user terminal may be served such as to be capable of executing the subsequent processing by receiving a signal that the authentication is successful.

### (3) Conclusion

As described above, the authentication method according to a first aspect is the authentication method for authenticating whether or not the target user is the specific user registered in advance. The authentication method includes the first step and the second step. The first step causes the voice including the predetermined character string to be output from the speaker 23. The second step acquires the voice information by receiving the utterance voice of the target user via the microphone 21 after the first step, and determines from the voice information whether the target user is the specific user or not. In the second step, at least two determinations are to be executed. In one determination, it is determined whether the character string recognized from the voice information is matched to the predetermined character string. In the other determination, it is determined whether the characteristics of the utterance voice of the target user is matched to the characteristics of the voice of the target user based on the characteristics amount recognized from the voice information and the characteristics amount of the voice information registered as the voice of the specific user in advance.

Also, in the second step, it may be furthermore determined, as a third determination, whether the time until the voice information is acquired from the time point when the first step is executed is within the predetermined time. The third determination is not mandatory. As a matter of course, the first, the second, and the third determinations may be performed with the order thereof altered.

According to this aspect, since it is possible to authenticate with the voice pronunciation, the authentication can be performed even for a person with visual impairment such as a person with weak eyesight and even for a person (a child, a foreigner, etc.) who cannot read characters. Also, according to the first aspect, it is not necessary to store the password unlike the conventional authentication method.

Also, according to the first aspect, even if the user's hands are occupied due to driving, cooking, parenting, or delivering luggage, the user can be authenticated in a natural conversation without manually inputting anything or displaying anything on the screen.

Also, according to the first aspect, since it is possible to authenticate in a conversation as is the case of the smart speaker (including the one in which such a function is included in the smartphone etc.) without manually operate the device, even a person who do not know how to use the device can also be authenticated in a natural conversation.

Also, according to the first aspect, in the second step, the authentication can be performed by following two types of determinations from the one-time utterance of the user, and the user does not feel of troubling at the time of the authentication. That is, according to the above authentication method, since two types of determinations are to be executed when the user answers (pronounces) once to a question from the device, the user does not have to answer questions many times, and therefore the user does not feel of troubling at the user authentication. That is, in a first determination, it is determined whether the character string recognized from the voice information is matched to the predetermined character string. In a second determination, it is determined whether the characteristics of the utterance voice of the target user is matched to the characteristics of the voice of the target user based on the characteristics amount recognized from the voice information and the characteristics amount of the voice information registered in advance as the voice of the specific user. In the first determination, the user does not have to remember the password. In the second determination, an authentication by a spoofing can be prevented.

With the authentication method according to the second aspect, in the first aspect, the predetermined character string is the ID information of the specific user registered in advance.

According to this aspect, it is possible to perform the authentication by using the character string that the target user is familiar with.

With the authentication system 1 according to the third aspect, it is the authentication system 1 having the speaker 23, the microphone 21 and the control unit 6. The control unit 6 causes the voice including the predetermined character string to be output from the speaker 23, and acquires the voice information by receiving the utterance voice of the target user via the microphone 21 thereafter, and determines from the voice information whether or not the target user is the specific user. The determination includes at least two determinations. In the first determination, it is determined whether the character string recognized from the voice information is matched to the predetermined character string. In the second determination, it is determined whether the characteristics of the utterance voice of the target user is matched to the characteristics of the voice of the target user based on the characteristics amount recognized from the voice information and the characteristics amount of the voice information registered in advance as the voice of the specific user.

In the determinations, as a third determination, the determination whether the time until the voice information is to be acquired from the time point when the first step is executed is within the predetermined time may further be performed. The third determination is not mandatory. As a matter of course, the first, the second, and the third determinations may be performed with the order thereof altered.

According to this aspect, since it is possible to authenticate with the voice pronunciation, the authentication can be performed even for a person with visual impairment such as a person with weak eyesight and even for a person (a child, a foreigner, etc.) who cannot read characters. Also, according to this aspect, it is not necessary to store the password unlike the conventional authentication method.

The device 2 according to the fourth aspect has the speaker 23, the microphone 21 and the control unit 6. The control unit 6 causes the voice including the predetermined character string to be output from the speaker 23, and acquires the voice information by receiving the utterance voice of the target user via the microphone thereafter, and determines whether or not the target user is the specific user from the voice information. The determination includes at least two determinations. In the first determination, it is determined whether the character string recognized from the voice information is matched to the predetermined character string. In the second determination, it is determined whether the characteristics of the utterance voice of the target user is matched to the characteristics of the voice of the target user based on the characteristics amount recognized from the voice information and the characteristics amount of the voice information registered as the voice of the specific user in advance.

In the determination, as a third determination, the determination whether the time until the voice information is to be acquired from the time point when the first step is executed is within the predetermined time may further be performed. The third determination is not mandatory. As a matter of course, the first, the second, and the third determinations may be performed with the order thereof altered.

According to this aspect, since it is possible to authenticate with the voice pronunciation, the authentication can be performed even for a person with visual impairment such as a person with weak eyesight and even for a person who cannot read characters. Also, according to this aspect, as the case of the aforementioned device, it is not necessary to store the password unlike the conventional authentication method.

The program according to the fifth aspect is a program for causing the computer 41 to execute the authentication method of the first aspect or the second aspect.

According to this aspect, it is possible to cause the voice authentication to execute with the program.

However, the second aspect is not an essential configuration in the authentication method of the present invention, and can be appropriately selected and employed.

### DESCRIPTION OF SYMBOLS

1. Authentication system
2. Device
21. Microphone
23. Speaker
6. Control unit

1. An authentication method of a smart speaker, which is executed in an authentication system of a smart speaker having a speaker, a microphone and a control unit, and which authenticates whether a target user is a specific user registered in advance,
wherein the control unit executes,
a first step of causing a voice including a predetermined character string to be output from the speaker, and
a second step of acquiring voice information by receiving an utterance voice of the target user via the microphone after the first step, and determining from the voice information whether the target user is the specific user or not, and
wherein the second step executes,
a determination whether a character string recognized from the voice information is matched to the predetermined character string, and
a determination whether characteristics of the utterance voice of the target user is matched to characteristics of the voice of the target user based on a characteristics amount recognized from the voice information and a characteristics amount of voice information registered in advance as the voice of the specific user, and
wherein the predetermined character string is a character string generated to cause the target user to recite at a time of an authentication.

2. The authentication method of a smart speaker according to claim 1,
wherein the second step further executes a determination whether a time until the voice information is to be acquired from a time when the first step is executed is within a predetermined time.

3. The authentication method of a smart speaker according to claim 1,
wherein a voice that prompts the utterance is output before or after causing the voice including the predetermined character string to be output in the first step.

4. An authentication system of a smart speaker having a speaker, a microphone and a control unit,
wherein the control unit is configured such as to,
cause a voice including a predetermined character string to be output from the speaker, and
acquire voice information by receiving an utterance voice of a target user via the microphone thereafter and determine from the voice information whether the target user is a specific user or not, and
wherein, in the determination, the control unit executes,
a determination whether a character string recognized from the voice information is matched to the predetermined character string, and
a determination whether characteristics of the utterance voice of the target user is matched to characteristics of the voice of the target user based on a characteristics amount recognized from the voice information and a characteristics amount of voice information registered in advance as the voice of the specific user, and
wherein the predetermined character string is a character string generated to cause the target user to recite at a time of an authentication.

5. The authentication system of a smart speaker according to claim 4,
wherein, in the determination, the control unit further executes a determination whether a time until the voice information is to be acquired from a time of causing the voice including the predetermined character string to be output from the speaker is within a predetermined time.

6. A smart speaker having a speaker, a microphone and a control unit,
wherein, the control unit is configured such as to,
cause a voice including a predetermined character string to be output from the speaker, and
acquire voice information by receiving an utterance voice of a target user via the microphone thereafter and determine from the voice information whether the target user is a specific user or not, and
wherein, in the determination, the control unit executes,
a determination whether a character string recognized from the voice information is matched to the predetermined character string, and
a determination whether characteristics of the utterance voice of the target user is matched to characteristics of the voice of the target user based on a characteristics amount recognized from the voice information and a characteristics amount of voice information registered in advance as the voice of the specific user, and
wherein the predetermined character string is a character string generated to cause the target user to recite at a time of an authentication.

7. The smart speaker according to claim 6,
wherein, in the determination, the control unit further executes a determination whether a time until the voice information is to be acquired from a time of causing the voice including the predetermined character string to be output from the speaker is within a predetermined time.

8. A program causing a computer to execute the authentication method according to claim 1.
